(19) United States
(12) Patent Application Publication
(10) Pub. No.: US 2008/0244381 A1
(43) Pub. Date: Oct. 2, 2008

(54) DOCUMENT PROCESSING FOR MOBILE DEVICES

(76) Inventors: Alex Nicolaou, Ontario (CA); Theodore B. Van Belle, Sunnyvale, CA (US); Michael F. Lueck, Ontario (CA); Kuan-Loong Yong, San Francisco, CA (US); Scott Jenson, Edina, MN (US)

Correspondence Address: FISH & RICHARDSON P.C., PO BOX 1022, MINNEAPOLIS, MN, 55440-1022, US

(21) Appl. No.: 12/060,113

(22) Filed: Mar. 31, 2008

Related U.S. Application Data
(60) Provisional application No. 60/909,356, filed on Mar. 30, 2007.

(51) Int. Cl. G06F 17/00

(52) U.S. Cl. 715/234

(57) ABSTRACT

The subject matter of this specification can be embodied in, among other things, a method that generates a table of contents for association with an electronic document that is requested by a client device. The subject matter also can be embodied in a method that reduces the emphasis of boilerplate in a requested electronic document and a method that manipulates log-in information so that the information is more easily accessible to a user of a client device displaying the requested electronic document.

### CROSS-REFERENCE TO RELATED APPLICATIONS

This application claims priority from U.S. Provisional Application Ser. No. 60/909,356, filed on Mar. 30, 2007, the contents of which are incorporated herein by reference.

### TECHNICAL FIELD

This instant specification relates to processing information for display on a mobile device.

### BACKGROUND

As computers and computer networks become more and more able to access a variety of dynamic web-based content, people are demanding more ways to obtain that content. Specifically, people now expect to have access, on the road, in the home, or in the office, to dynamic content previously available only from a permanently-connected personal computer hooked to an appropriately provisioned network. They want to view web pages with dynamically loaded navigation menus from their cell phones, track purchases in an online shopping cart from their personal digital assistants (PDAs), and validate entered information in online forms from their palm tops. They also want all of this dynamic content when traveling, whether locally, domestically, or internationally, in an easy-to-use, portable device.

Portability generally requires a device small in size, which in turn limits the screen area available for displaying content. This limitation may require the portable device to reduce content to an illegible or unrecognizable state when displayed on a small screen. Alternatively, the content may be displayed at a larger size, but a user must scroll to see some parts of the content.

### SUMMARY

In general, this document describes generation of a table of contents for association with an electronic document that is requested by a client device. The document also describes reducing the emphasis of boilerplate in a requested electronic document and the manipulation of log-in information so that it is more easily accessible to a user of the client device.

In a first general aspect, a computer-implemented method for processing information for display on a mobile device is described. The method includes receiving a request from a mobile device for an electronic document, identifying entries for a table of contents (ToC) based on formatting information or content of the electronic document, and outputting, for insertion in the electronic document, a ToC identifier used by an application on the mobile device to enable a user to access the ToC from a first-viewed portion of the electronic document that is displayed substantially before other portions of the electronic document that are available for display to the user.

In a second general aspect, a system is described. The system includes an interface to receive a request from a mobile device for an electronic document and a parser to identify entries for a table of contents (ToC) based on formatting information or content of the electronic document. The system also includes means for outputting, for insertion in the electronic document, a ToC identifier used by an application on the mobile device to enable a user to access the ToC from a first-viewed portion of the electronic document that is displayed substantially before other portions of the electronic document that are available for display to the user.

In a third general aspect, a computer-implemented method is described. The method includes receiving a request at a first server from a client device for an electronic document hosted at a second server, retrieving the requested electronic document from the second server, and generating a table of contents (ToC) for the electronic document. The entries in the ToC are generated based on formatting information or content of the electronic document. The method also includes transmitting the ToC to the client device in association with the electronic document for use in accessing content of the electronic document.

In yet other general aspects, a computer-implemented method for processing information for display on a mobile device is described. The method includes storing first content of a initial electronic document, receiving a request for a second electronic document from a mobile device, and comparing the first content of the initial electronic document with second content of the second electronic document to determine whether at least a portion of the second content is repetitive content that exceeds a threshold of similarity. The method also includes outputting, for display on the mobile device, a modified second document that deemphasizes at least a portion of the repetitive content.

In some implementations, the method further comprises deemphasizing the portion of the repetitive content by changing a color of the repetitive content. For example, the color can be changed to gray. Additionally, the method can further comprise deemphasizing the portion of the repetitive content by removing the repetitive content. Also, the method can further comprise deemphasizing the portion of the repetitive content by replacing the repetitive content with a link to the repetitive content. For example, the link can comprise at least a portion of the repetitive content.

The method can further comprise deemphasizing the portion of the repetitive content by obscuring or muting the repetitive content. In some implementations, the modified second document comprises a repetitive content identifier used to deemphasize the portion of the repetitive content. For example, the repetitive content identifier can comprises an anchor tag that identifies a beginning of non-repetitive content.

In some implementations, the repetitive content identifier is configured to control the mobile device so that the non-repetitive content is included in a first portion of content displayed to a user of the mobile device. The second modified document can comprise a link that references the anchor tag so that the non-repetitive content is displayed when a user selects the link. Additionally, the repetitive content identifier can comprise a markup tag that modifies the appearance or audio of the repetitive content.

In some implementations, the repetitive content comprises, text, images, video, audio, or a combination thereof. The method can further comprise a request to reemphasize the repetitive content. For example, the request can comprise a command to scroll up to view the repetitive content. In another example, the request can comprise a command to restore previously removed repetitive content. In yet another example, the request is to output previously truncated repetitive content in an expanded, second-viewed position.

In another general aspect, a computer-implemented method for processing information for display on a mobile device is described. The method includes receiving a request from a mobile device for an electronic document, parsing the electronic document for content associated with a login element on a graphical user interface, and outputting, for insertion in the electronic document, a login identifier used by an application on the mobile device to enable a user to access the login element from a first-viewed portion of the electronic document that is displayed first to the user.

In some implementations the method further comprises identifying the login element based on a formatting tag within the electronic document. For example, the formatting tag can comprise an input tag that specifies a user interface element that accepts input from a user of the mobile device. In another example, the login identifier comprises a link to the login element that, when selected, causes the mobile device to display the login element. In yet another example, the login identifier comprises an anchor tag located substantially near the login element. The method can also comprise a link that references the anchor tag, wherein selection of the link causes the mobile device display a second-viewed portion that includes the login element. Additionally, the method can further comprise receiving a first selection of a control associated with the login identifier and outputting the login element in an expanded, second-viewed position

### DESCRIPTION OF DRAWINGS

FIG. 1 is a schematic diagram of an exemplary system for processing an initial electronic document for execution on a mobile communication device.

FIG. 2 is a block diagram of the system of FIG. 1 showing more detail according to one implementation.

FIG. 3 is a sequence diagram of exemplary operations that can be performed when processing an initial electronic document for display on a mobile communication device.

FIG. 4 is an example of a transcoded electronic document that includes a table of contents.

FIG. 5 is an example of a transcoded electronic document that includes a login identifier.

FIG. 6 includes an example of a transcoded electronic document, which has a reduction of repetitive text.

FIG. 7 is an example of a transcoded electronic document that includes a progress monitor.

FIG. 8 is a block diagram of computing devices 800, 850 that may be used to implement the systems and methods described in this document.

Like reference symbols in the various drawings indicate like elements.

### DETAILED DESCRIPTION

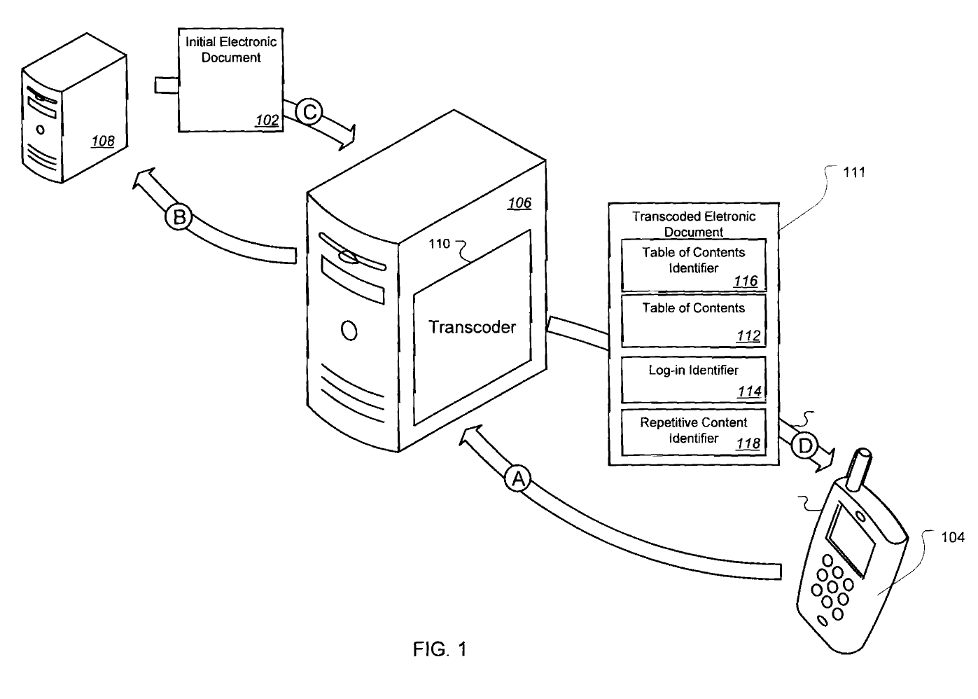

FIG. 1 is a schematic diagram of an exemplary system 100 for processing an initial electronic document 102 for execution on a mobile communication device 104. The mobile communication device 104, also referred to as the remote device, may send a request to a server system 106 for an initial electronic document, as represented by the arrow labeled “A.” In some implementations, the server system 106 forwards the request for the initial electronic document to a remote web server 108, as represented by the arrow labeled “B.” In response to the request, the remote web server 108 can send the initial electronic document 102 to the server system 106, as represented by the arrow labeled “C.” In some implementations, the initial electronic document 102 can be a web page. The web page can include a variety of components, such as a login box or boxes, headings describing content of the web page, images, video, text, etc.

In one example, the process illustrated by arrows A, B, and C, occurs when a user of the remote device 104 views a list of web page links retrieved from a web search performed by the server system 106. The list may include a web page link specifying a web page at the remote web server 108 such as:

http://www.remotewebserver.com/first_document.html.

The server system 106 may modify the actual Uniform Resource Locator (URL) accessed when the user selects the web link above so that the link is first directed to the server system 106, such as in the following URL:

http://www.google.com/?u=www.remotewebserver.com/first_document.html.

Here, “www.google.com” is the network address of the server system 106. The “?u=www.remotewebserver.com/first_document.html” parameter in the URL directs the server system 106 to request from the remote web server 108 the initial electronic document 102 located at

“www.remotewebserver.com/first_document.html.”

The server system 106 may include a transcoder 110 for processing the initial electronic document 102. In some implementations, the transcoder 110 can generate a table of contents 112 (ToC) based on formatting information and content of the initial electronic document 102. For example, the transcoder 110 can parse the initial electronic document 102 to identify formatting information, such as markup language tags, that indicate particular text should have an increased font size, be bolded, be italicized, or be emphasized in another way. Text that is emphasized can be used to generate entries in the ToC 112.

Additionally, content of the initial document, such as text and images (and their positional attributes), that are displayed can be used to identify ToC entries. For example, the transcoder 110 can generate an entry using text at the beginning of a paragraph. In another example, text that is associated with an image, such as a caption for the image, can be used to generate an entry. In another example, the transcoder 110 can generate a ToC entry using text that is alternatively displayed if the image is not displayed.

In other implementations, the transcoder 110 can process the initial electronic document 102 by generating a login identifier 114 that enables a user to access a login element on a portion of the request electronic document that is first presented to the user. For example, the transcoder 110 can parse an electronic document that is requested by a mobile device in order to identify login elements, such as user input boxes for a user name and password. The transcoder 110 can then generate a link to a section of the electronic document that includes the login element. In some implementations, the transcoder 110 can generate a transcoded document 111 that includes the content of the requested electronic document and as well as the link to the login element. The link can be inserted at a portion of the transcoded document 111 that is displayed substantially first to a user so that the user can “jump” to the login element by clicking the link.

In still other implementations, the transcoder 110 can process the electronic document by deemphasizing repetitive content present in the electronic document. For example, a user may request and view a first electronic document on his mobile device, where the first electronic document includes text describing a product's feature set. If a second electronic document is requested that includes the same or similar text describing the feature set, the transcoder 110 can generate a transcoded electronic document 111 that deemphasizes the repetitive text by, for example, generating an anchor tag that enables the mobile device to display a section of the electronic document that does not include the repetitive text (e.g., when displayed, the second electronic document skips over the repetitive text and displays a portion that has non-repetitive text).

The repetitive content is not limited to text. In some implementations, the repetitive content can include images, audio, video, and other media or information included in the electronic document.

In other examples, the transcoder 110 can generate a transcoded electronic document 111 that deemphasizes the repetitive text in other ways, such as “graying” the text out, decreasing the font size, or replacing the text with a link that is displayed as a truncated version of the text and lets a user view the full text when the link is selected. In still other examples, the transcoder 110 can deemphasize the repetitive text by removing it, obscuring it with another element on the page, such as an image, or by encapsulating the text in a user interface element that can be expanded by a selection of the user if the user wishes to display the repetitive text.

As discussed above, the transcoder 110 can process the initial electronic document 102 that was requested by a user and generate a transcoded, or second, electronic document 111. The second document may be in a web accessible format, such as HTML (Hypertext Markup Language), Extensible Markup Language (XML), and Wireless Markup Language (WML). In certain implementations, the second document can include a ToC identifier 116, a ToC 112, a login identifier 114, or a repetitive content identifier 118.

The ToC identifier 116 can be a link used to access the ToC 112, and the login identifier 114 can also be a link used to access a login element within the transcoded document 111. In some implementations, both links can be displayed in a portion of the transcoded document 111 that is displayed substantially first to a user. The user can select the links to either navigate to another portion of the document that includes the element or the user can select the link to expand a user interface element to reveal a login element or ToC.

Additionally, the ToC identifier 116 can include a mark-up tag, such as an HTML tag, that is used to indicate the presence of a ToC. In some implementations, instead of the ToC identifier 116 being a link to a ToC, the ToC may be displayed after the ToC identifier 116. For example, when a transcoded electronic document 111 is displayed to a user, at least a part of the ToC 112 is displayed in a portion of the document that is displayed substantially first to the user. In this example, the ToC identifier 116 can be used by the display device to indicate that the ToC 112 should be inserted at a point indicated by the ToC identifier 116, namely, within the first portion of the transcoded electronic document 111 that is displayed to the user.

In certain implementations, the repetitive text identifier can include a formatting tag inserted before or after the repetitive text that informs a viewing application that the text should be deemphasized, for example, by changing the color of the font, decreasing the font size, etc. In other implementations, the repetitive text identifier can include an anchor tag that is inserted after that repetitive text. The application used to view the second electronic document can use the tag to display content that occurs after the tag first instead of first displaying repetitive text that occurs before the anchor tag.

As shown in FIG. 1, the server system 106 transmits the second document to the remote device 104, as represented by the arrow labeled “D.” The remote device 104 may then display the second document to the user.

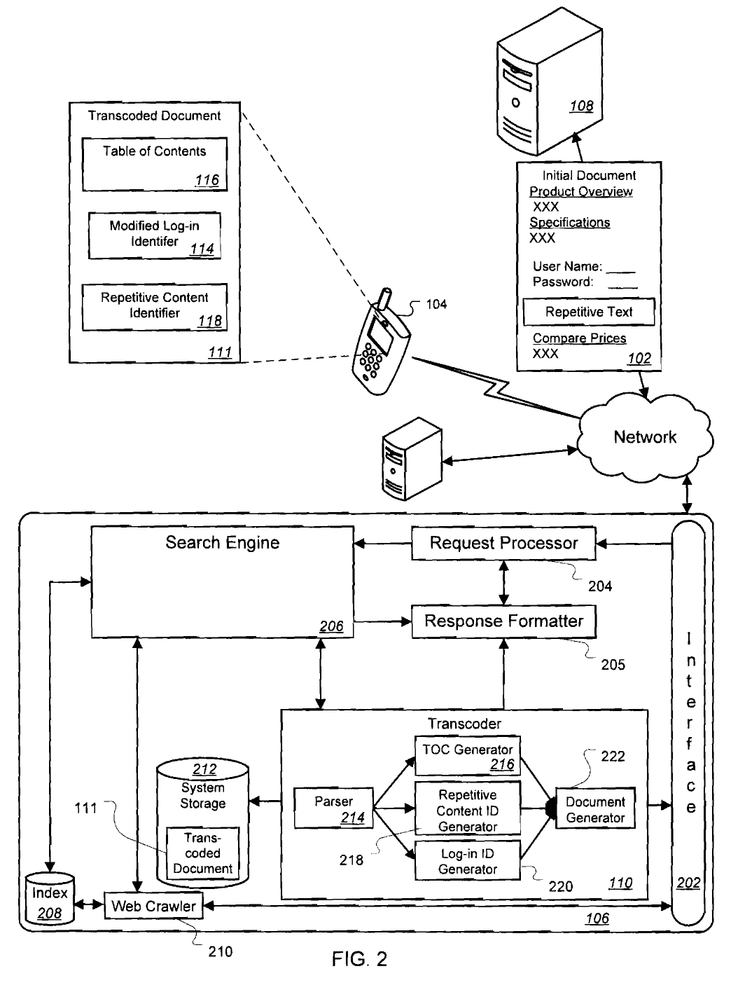

FIG. 2 is a block diagram of the system of FIG. 1 showing more detail according to one implementation. FIG. 2 shows the server system 106 and devices in communication with it. The server system 106 may be implemented, for example, as part of an Internet search provider's general system.

The server system 106 is provided with an interface 202 to allow communications with a network, such as the Internet. The server system 106 may communicate with various devices, such as the remote device 104 and the remote web server 108. The communication flow for any device may be bidirectional so that the server system 106 may receive information, such as commands, from the devices, and may send information to the devices.

Commands and requests received from devices may be provided to a request processor 204, which may interpret a request, associate it with predefined acceptable requests, and pass it on, such as in the form of a command to another component of the server system 106 to perform a particular action. For example, in an implementation where the server system 106 is part of the Internet search provider's general system, the request may include a search request. The request processor 204 may cause a search engine 206 to generate search results corresponding to the search request. The search engine 206 may use data retrieval and search techniques like those used by the Google PageRank™ system. The results generated by the search engine 206 may then be provided back to the original requester using a response formatter 205, which carries out necessary formatting on the results.

The search engine 206 may rely on a number of other components for its proper operation. For example, the search engine 206 may refer to an index 108 of web sites instead of searching the web sites themselves each time a request is made, so as to make the searching much more efficient. The index 108 may be populated using information collected and formatted by a web crawler 210, which may continuously scan potential information sources for changing information.

The transcoder 110 may access a system storage 212. The system storage 212 may be one or more storage locations for files needed to operate the system, such as applications, maintenance routines, and management and reporting software. In some implementations, the transcoder 110 may store the transcoded, or second, document 111 in the system storage 212. The server system 106 may transmit the stored second electronic document in response to future requests for the initial electronic document 102.

The transcoder 110 may include several components used to process the initial electronic document 102. A parser 214 may identify elements within the initial electronic document 102 that are associated with login elements, elements that are used to generate a ToC, and elements that are used to determine whether repetitive content exists.

For example, the parser 214 can identify text associated with an HTML heading tag. The text associated with the heading tag can be passed to a ToC generator 216, which creates an entry for the ToC 112 using all or a portion of the text.

In another example, the parser 214 can compare content, such as text, with content displayed to a user in a previously requested page. In one implementation the comparison includes a string comparison, where text in a currently requested electronic document is compared word for word with text in a past document that was previously requested by a user. In some implementations, the past document may be the document that was immediately viewed prior to the request for the currently requested electronic document. In other implementations, several past documents (e.g., the past five documents) may compared to the currently requested document to determine whether repetitive text exists.

The determination whether content is repetitive may be based on a threshold of similarity. For example, the parser 214 may determine that a block of text is repetitive text if 90% (the threshold of similarity) of the text is common to text previously viewed by a user. This threshold can be set by an administrator of the transcoder 110.

Once the repetitive content is identified by the parser 214, the location or attributes of the repetitive text can be passed to a repetitive content identification (RCI) generator 218. The RCI generator 218 can create an identifier that is used to deemphasize the content. For example, the RCI generator 218 can generate an anchor link for insertion after the repetitive text, where the anchor is used to skip the repetitive text and display the non-repetitive text when the requested document is displayed on a mobile device.

The parser 214 can also identify login elements within the initial electronic document 102. For example, the parser 214 can identify formatting tags that specify a user input element, such as a form field, that have an attribute type equal to “password” or “username.” The location of the login elements or information used to generate the login elements (e.g., XML tags) can be passed to the login identifier generator 220, which can create a login identifier associated with the login elements.

In certain implementations, the login identifier 114 is a link to the position of the login elements as described above. In other implementations, the login identifier 114 can include information used to generate the login element at a position different from its position within the initial electronic document 102. For example, the login identifier 114 can specify that the login element should be displayed at the top of the transcoded document 111 so that it may be viewed upon loading of the transcoded document 111 without requiring additional navigation, such as scrolling down the document to locate the login element.

The parser 214 can decode the initial electronic document 102 using an application programming interface (API) to access the content of the initial electronic document 102. For example, if the initial electronic document 102 is a web page, the parser 214 may access the elements, or document objects, of the web page using a document object model (DOM) API. Using the DOM API, the parser 214 may load the document objects from the initial electronic document 102 into memory using a data structure, such as a tree. The DOM may allow the document objects to be accessed randomly, or in an order different from the order in which they are specified in the initial electronic document 102. Alternatively, the parser 214 may input the initial electronic document 102 as a series of characters or character strings. The characters or strings may be serially compared with a set of predefined identifiers that specify the existence of elements to be identified, such as the HTML “<input type=“password”>” tag, which can be used to identify login elements.

In some implementations, the transcoder 110 may determine whether to process the initial electronic document 102. For example, the transcoder 110 may contain a list of web sites that have contracted to have the server system 106 process their web pages. The parser 214 may choose to process only those web pages that belong to web sites included in the list. In another implementation, the transcoder 110 may only process a portion of the initial electronic document 102. For example, the initial electronic document 102 may be a web site www.website.com. The web site may contain advertising content generated that includes log-in elements or repetitive text, where the first advertiser is cheapcars.com and the second advertiser is expensivecars.com.

Expensivecars.com may pay a fee to have its advertisements processed by the transcoder 110. An identifier associated with expensivecars.com may be recorded in an index 108 that is accessed to determine whether a particular electronic document should be processed. The transcoder 110 may parse the electronic document to determine if it contains an identifier that matches an identifier in the index 108. If a match is found, the electronic document may be processed. Here, the identifier may be the text “expensivecars.com.” The transcoder 110 may examine the electronic document and determine that it retrieves content from expensivecars.com's web server. The electronic document is processed by the transcoder 110 because expensivcars.com is included in the index 108. The electronic document that retrieves content from the cheapcars.com web site, however, would not be processed because no matching entry is present in the index 108.

The transcoder 110 may also include a document generator. In one implementation, the document generator creates the transcoded, or second, document 111 using content from the initial electronic document 102 and information from the ToC generator 216, the RCI generator 218, and the Login identifier 114 generator.

Additionally, the document generator may modify hyperlinks to other web pages in the second document so that they are first directed to the server system 106 for processing. For example, an element within the initial electronic document 102 may have an associated HTML attribute specifying a hyperlink to another web page. The web page may be located at a second remote web server. The document generator may add a clickable link to the second document corresponding to the hyperlink in the initial electronic document 102. The clickable link within the second document may contain the network address of the server system 106. In a manner similar to the search list described above, the hyperlink first directs the web page request to the server system 106, where the server system 106 will retrieve the web page and forward it to the remote device 104 after processing the web page. For example, the initial electronic document 102 may contain the following hyperlink to another document at the second remote web server:

http://www.secondwebserver.com/another_document.html.

The document generator modifies the hyperlink so that it is first directed to the server system 106, such as in the following URL:

http://www.google.com/?u=www.secondwebserver.com/another_document.html.

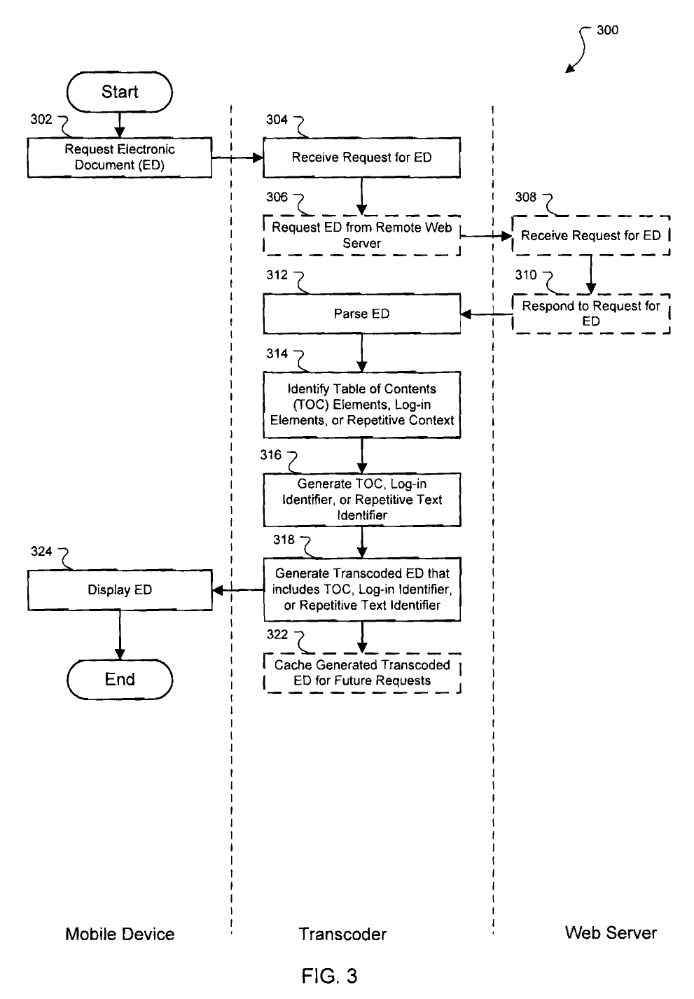

FIG. 3 is a sequence diagram of exemplary operations 300 that can be performed when processing an initial electronic document for display on a mobile communication device. For example, the operations 300 can be performed in the server system 106. A processor executing instructions stored in a computer program product can perform the operations 300. The operations 300 begin in step 302 with a request from a remote device for a first electronic document, such as a mobile communication device. For example, the user of the remote device 104 may send the request to the server system 106 for the first electronic document.

In step 304, a server system receives the request for the first electronic document from the remote device. For example, the server system 106 may receive the request for the first electronic document 102 from the remote device 104.

In optional step 306, the server system may make a request to a remote web server for the first electronic document. In optional steps 308 and 310, the remote web server may receive the request for the first electronic document and send a response including the first electronic document to the server system, respectively. For example, the server system 106 may request from the remote web server 108 the first electronic document 102 and the remote web server may send a response including the first electronic document 102.

In step 312, the first electronic document is parsed. For example, the server system 106 includes the parser 214, which is capable of parsing the first electronic document 102 elements as described in association with the FIG. 2.

In step 314, ToC elements, login elements, and repetitive context are identified. For example, in identifying login elements, the parser 214 can compare formatting tags within the initial electronic document 102 to a stored list of formatting tags to determine if the initial electronic document 102 includes form field of type “password.”

In step 316, a ToC identifier, a login identifier, or a repetitive context identifier is generated. Additionally, ToC entries may also be generated. For example, the parser 214 can select text positioned above a formatting tag indicating the start of a paragraph (e.g., <p>). This text, or a portion of this text, can be used to generate a ToC entry that is displayed as a link that navigates to the paragraph when a user selects the link. In some implementations, the ToC identifier may be a link entitled “Table of Contents,” that navigates to the list of ToC entries when selected by a user.

In step 318, a transcoded electronic document is generated that can include the ToC identifier (and ToC), the login identifier, and the repetitive context identifier. For example, the document generator 222 may generate a web page that includes a ToC and a link for a user to navigate to the ToC.

The server system transmits the transcoded electronic document to the remote device. For example, the server system 106 may transmit the transcoded electronic document 111 to the remote device 104 over the network using the interface 202.

Additionally, in step 322, the generated transcoded electronic document can be stored. For example, the transcoder 110 can store the transcoded electronic document in the system storage 212. In certain implementations, when a subsequent request is received for an electronic document from which the transcoded document 111 was derived, the transcoder 110 can retrieve and transmit the stored transcoded electronic document 111 instead of generating it.

In step 324, the remote device displays the transcoded electronic document. For example, a mobile device that receives the transcoded electronic document 111 can execute an application, such as a web browser, that displays the received document.

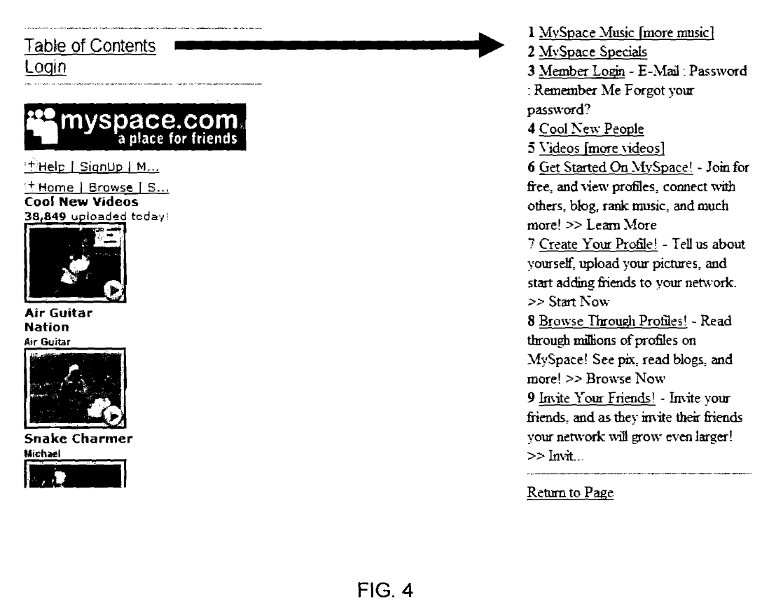

FIG. 4 is an example of a transcoded electronic document that includes a table of contents. In this example, the ToC is accessed by selection of a link labeled “Table of Contents,” where the link is embedded at the top of a web page that is first displayed to a user when a requested web page is loaded on a mobile device. In this implementation, the ToC identifier includes this link.

When the user selects the link, a ToC is displayed. The ToC can include ToC entries that were generated based on HTML tags, such as heading tag <H1>, that were present in an initial web page that is parsed. Text between the heading tag can be extracted and used as a ToC entry. Additionally, snippets selected from the text following the heading can be appended to the ToC entry, as shown in FIG. 4.

In some implementations, a ToC entry is a link that takes a user to a portion of the electronic document that includes the text from which the ToC entry was generated. For example, if the text “Cool New People” was extracted from the middle of a web page, selection of the ToC entry that corresponds to this entry would cause the mobile device to display the text in the middle of the web page.

In certain implementations, this is accomplished by generated an anchor tag (e.g., <a>) that is inserted substantially near the text from which the entry was generated. The ToC entry references the anchor so that when the ToC entry is selected, the mobile device (more specifically an application, such as a browser) locates the anchor and displays the text referenced by the anchor.

In another implementation (not shown in FIG. 4), the text “Table of Contents” may be a user interface element that expands when selected to display the ToC entries-. For example, the text “Table of Contents” can have a “plus” sign beside it indicating that the element expands when it is selected by a user.

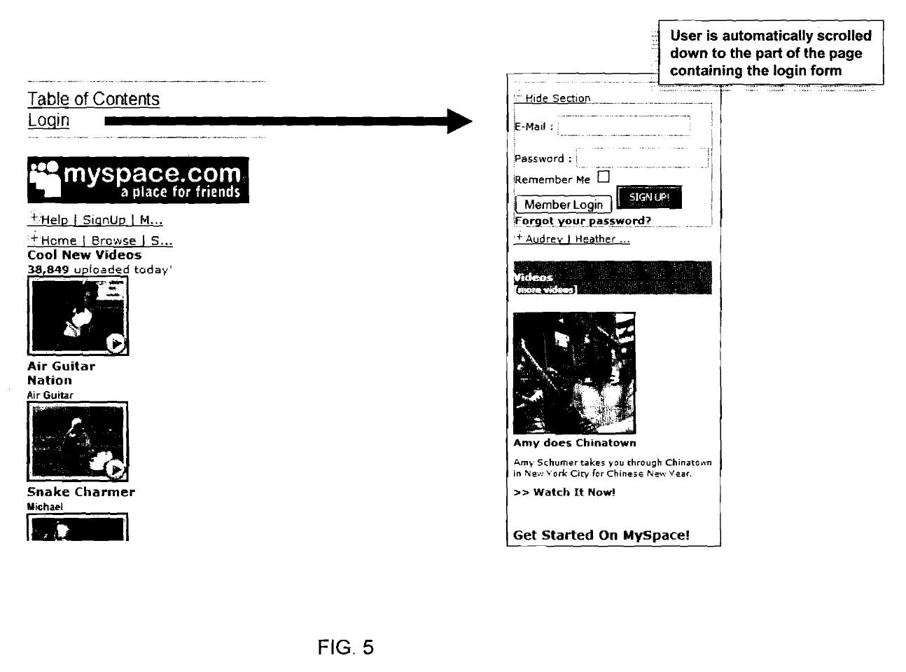

FIG. 5 is an example of a transcoded electronic document that includes a login identifier. In this example, the login identifier can be the link labeled “Login.” When a user selects the link, the mobile device displays a portion of the transcoded document that includes the login element.

In some implementations, the login element is located by the parser as discussed above. The document generator can insert an anchor <a> near (e.g., ahead) of the login element. The login identifier can be a URL that references the anchor, so that when the login identifier is selected, the mobile displays the login element.

In another implementation (not shown in FIG. 5), the login identifier includes code that can be used to generate the login element. The login identifier can be displayed at the top of the electronic document so that a user sees the login element as soon as the page is displayed. For example, this may accomplish a “cut and paste” effect, where the login element is moved from a different section in the electronic document to a portion of the document that is first displayed to the user (e.g., the top of the first chunk of page displayed in a mobile browser). In some implementations, the original code for the login is not removed so that the login element only appears in a different portion of the electronic document, but is instead copied. In this way, the login element may be present in more than one section of the electronic document.

In yet another implementation, the login identifier may be part of an expandable user interface element, similar to the user interface element described in association with the ToC identifier. In other implementations, the login element is part of the expandable user interface element regardless of the element's placement with the electronic document. For example, referring to FIG. 5, the login element is included within an expandable user interface element labeled “Hide Section.”

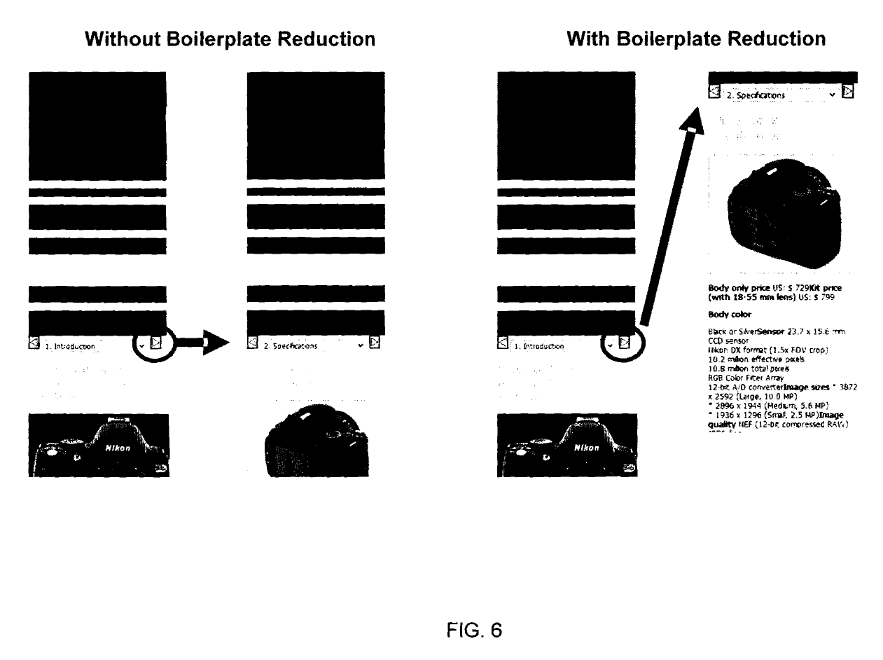

FIG. 6 is an example of a transcoded electronic document, which has a reduction of repetitive text. More specifically, the example shows two scenarios. The first scenario includes two screens that a user would see without a reduction in repetitive content. The second scenario is two screens that the user would see with a reduction in repetitive content.

In the first scenario, an application (e.g., a browser) displays a first web page that has information about a camera. A user selects a right arrow to navigate to a different web page. The second web page displayed includes much of the same text that was included in the first web page. Similar text is indicated in FIG. 6 using the grayed blocks. The user would have to scroll or otherwise manually navigate past the repetitive text to view new text.

In the second scenario, the application displays the first web page just as in the first scenario. However, when a user selects the right arrow to navigate to the second web page, the application displays a portion of the web page that occurs after the repetitive content. This may permit the user to view the new content without having to manually navigate to the new content. In certain implementations, the user may scroll or otherwise navigate up to view the repetitive text.

In some implementations, reduction of repetitive text can be accomplished by storing the content of the first electronic document and comparing the content of the first electronic document to content of a second electronic document. For example, the transcoder 110 can store the content in the system storage 212. The content can include text, images, video, audio, etc. In some implementations, the formatting information can be excluded from the content that is saved.

When a second electronic document is requested, the transcoder 110 can compare the contents of the first and second document. For example, the transcoder 110 can execute a string compare on text content to determine what, if any, text is similar between the first and second electronic documents. If repetitive text exists, the transcoder 110 can insert an anchor tag after the repetitive text, which causes the application on the mobile device 104 to display the non-repetitive text when the second electronic document is displayed to the user.

In other implementations, the transcoder can compare file names, file sizes, or one or more bytes of media, such as audio files, video files, or images, to determine whether they are repetitive content. For example, if an audio file in the second electronic document has the same file name or file path as an audio file in the first electronic document, the transcoder can modify the second electronic document so that it does not play the audio file (e.g., removes the HTML that specifies that the audio file should be played or generates HTML code that instructions the application to mute the audio file). A similar process may be performed for video files.

If an image is determined to be repetitive, the transcoder can remove it from the second document or reposition it so that the image is not displayed when the second electronic document is first loaded. For example, the image can be repositioned above the non-repetitive content, similar to the position of the repetitive text in the second scenario.

In other implementations, repetitive content (e.g., text, images, video, etc.) can be included in a user interface element that a user may expand if the user wishes to view the repetitive content.

In yet another implementation, multiple repetitive content identifiers can be generated and inserted in the second document. This may allow a user to skip repetitive content by selecting a link that navigates to the next section of non-repetitive content. For example, a block of non-repetitive text may be followed by a block of repetitive text. The document generator may embed two tags that permit a user to skip over the repetitive text. In certain implementations, the first is an anchor tag that identifies the next block of non-repetitive text, and the second is a link that references the anchor tag and navigates to the tag when selected by a user. The link may be positioned after the non-repetitive text so that after reading the block of non-repetitive text, the user may select the link, which causes the application to skip of the following block of repetitive text to the next block of non-repetitive text.

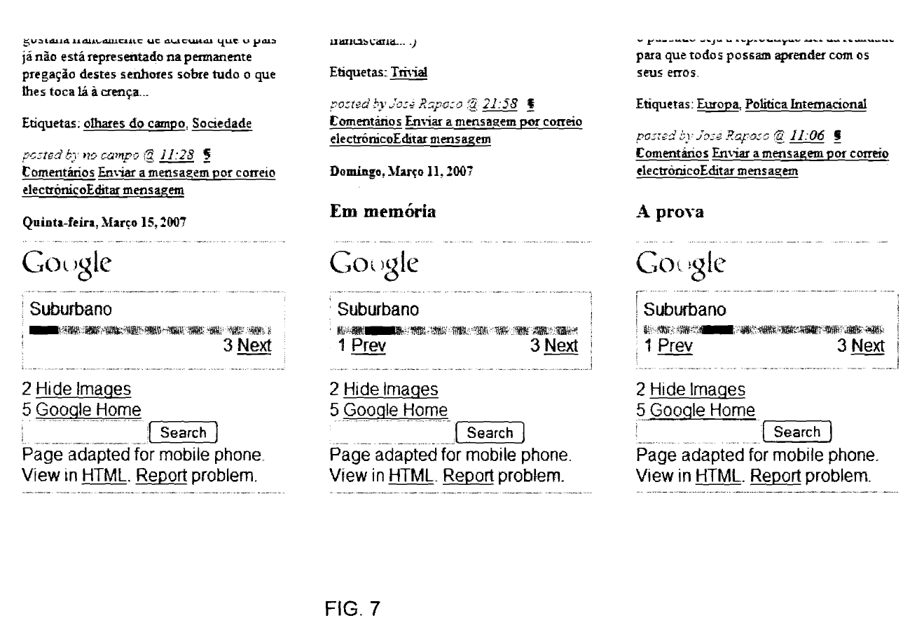

FIG. 7 is an example of a transcoded electronic document that includes a progress monitor. In certain implementations an electronic document can be segmented into multiple sections, or chunks for display on a small screen. A progress monitor can be displayed by a mobile device to inform a user which chunk he or she is currently viewing.

In some implementations, the chunks are sequential divisions of a web page from the top of the web page to the bottom. For example, the first chunk would be a topmost portion of the web page, the second chunk would be a portion below that, and so on, until the last chunk, which would include the bottommost portion of the web page.

In other implementations, the chunks are not sequential, but may be based on sections or frames that are specified by the electronic document. For example, a login section may be one chunk, legal notices a second chunk, and a search box within a frame may be a third chunk.

The progress bar can include navigation elements that allow a user to move between different electronic documents (e.g., web pages) or within chunks of a single electronic document. For example, the “prev” and “next” navigation elements enable a user to navigate to a previous and next web page, respectively.

The highlight section within the progress bar can display which chunk within an electronic document a user is currently viewing. In the first screenshot, the user is viewing a first chunk, and in the second screenshot, the user is viewing a second chunk. If a user wishes to navigate to a third chunk, he can select a point in the progress bar at which the third chunk would appear, as shown in the third screenshot.

The length of the highlighted section can also be dynamically updated to reflect how many chunks are within the electronic document. For example, if there are only two chunks, the highlighted section can be very large relative to the progress bar's total length (e.g., the section can take up half of the progress bar). If there are many chunks, the highlighted section can be smaller (e.g., if there are ten chunks, the highlighted section can be one tenth of the size of the progress bar).

In some implementations, the progress bar is displayed in a static position as the user navigates through the electronic document. For example, as shown in FIG. 7, the progress bar can remain at the bottom of the display.

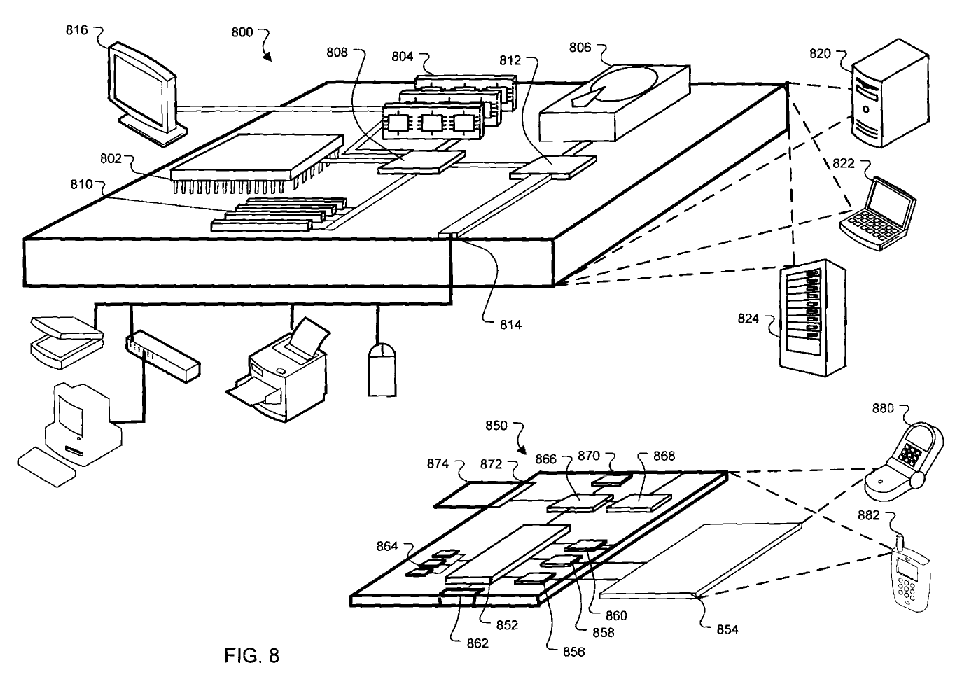

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on processor 802, or a propagated signal.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, memory on processor 852, or a propagated signal that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In some implementations, the display of particular sites can be customized. When a request is made for one of these sites, the transcoder include elements such as the ToC or login identifiers based on a predetermined template. For example, a social networking site may have a defined structure for the site, such as a profile section, a comment section, a photograph section, etc. The transcoder can determine this site is on a list of sites which are custom transcoded and can, for example, construct the ToC based on the defined structure for the site. Similarly, this customization can be applied to the placement of the login identifier and the repetitive content identifier.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for processing information for display on a mobile device, the method comprising:
receiving a request from a mobile device for an electronic document;
identifying entries for a table of contents (ToC) based on formatting information or content of the electronic document; and
outputting, for insertion in the electronic document, a ToC identifier used by an application on the mobile device to enable a user to access the ToC from a first-viewed portion of the electronic document that is displayed substantially before other portions of the electronic document that are available for display to the user.

2. The method of claim 1, wherein the ToC identifier comprises the ToC in a collapsed form.

3. The method of claim 2, further comprising receiving from the user a first selection of a control associated with the ToC identifier and displaying the ToC in an expanded form.

4. The method of claim 3, wherein the control associated with the ToC identifier comprises a selectable plus sign.

5. The method of claim 3, further comprising receiving a second selection of the control associated with the ToC identifier and displaying the ToC in the collapsed form.

6. The method of claim 1, wherein identifying the entries for the ToC comprises identifying formatting tags in a markup document.

7. The method of claim 6, wherein the formatting tags are selected from a group consisting of heading tags, font tags, bold tags, italicize tags, and anchor tags.

8. The method of claim 1, wherein identifying the entries for the ToC comprises identifying text associated with an image.

9. The method of claim 1, wherein identifying the entries for the ToC comprises identifying text positioned before a text block or positioned as a first sentence in a text block.

10. The method of claim 1, wherein identifying entries for a ToC is performed after the request for the electronic document is received.

11. The method of claim 1, wherein the ToC identifier comprises a first link to a different electronic document that includes the ToC.

12. The method of claim 11, wherein the different electronic document includes a second link that enables the user to navigate back to the electronic document that includes the ToC identifier without selecting an entry in the ToC.

13. The method of claim 1, wherein the ToC comprises one or more entries, wherein at least one entry comprises a link that initiates a display of content identified by the entry when the link is selected by the user.

14. The method of claim 1, further comprising storing a copy of the electronic document having the inserted ToC identifier.

15. The method of claim 14, further comprising transmitting the stored copy of the electronic document in response to the request for the electronic document instead of retrieving the electronic document from a remote web server.

16. The method of claim 1, further comprising logically dividing the electronic document into multiple segments.

17. The method of claim 1, further comprising outputting for insertion in the electronic document, a progress bar to indicate to a user which segment is displayed to the user.

18. The method of claim 1, further comprising:
storing first content of the electronic document;
receiving a request for a second electronic document from the mobile device;
comparing the first content of the electronic document with second content of the second electronic document to determine whether at least a portion of the second content is repetitive content that exceeds a threshold of similarity; and
outputting, for display on the mobile device, a modified second document that deemphasizes at least a portion of the repetitive content.

19. A system comprising:
an interface to receive a request from a mobile device for an electronic document;
a parser to identify entries for a table of contents (ToC) based on formatting information or content of the electronic document; and
means for outputting, for insertion in the electronic document, a ToC identifier used by an application on the mobile device to enable a user to access the ToC from a first-viewed portion of the electronic document that is displayed substantially before other portions of the electronic document that are available for display to the user.

20. A computer-implemented method comprising:
receiving a request at a first server from a client device for an electronic document hosted at a second server;
retrieving the requested electronic document from the second server;
generating a table of contents (ToC) for the electronic document, wherein entries in the ToC are generated based on formatting information or content of the electronic document; and
transmitting the ToC to the client device in association with the electronic document for use in accessing content of the electronic document.
